(19) United States
(12) Patent Application Publication
(10) Pub. No.: US 2026/0299164 A1
(43) Pub. Date: Oct. 1, 2026

(54) DEFORMATION SENSING AND OBJECT IDENTIFICATION WITH COLOR-DYNAMIC MECHANO-RESPONSIVE PHOTONIC MATERIALS

(71) Applicant: Massachusetts Institute of Technology, Cambridge, MA (US)

(72) Inventors: Mathias Kolle, Hull, MA (US); Benjamin Miller, Cambridge, MA (US); Raphael Pesch, Karlsruhe (DE); Max T. Thomsen, Cambridge, MA (US)

(73) Assignee: Massachusetts Institute of Technology, Cambridge, MA (US)

(21) Appl. No.: 18/996,502

(22) PCT Filed: Aug. 16, 2023
(86) PCT No.: PCT/US2023/072340

§ 371 Date: Jan. 17, 2025

Related U.S. Application Data
(60) Provisional application No. 63/371,539, filed on Aug. 16, 2022.

(51) Int. Cl. G02B 1/00; G01J 3/46

(52) U.S. Cl. CPC G02B 1/005; G01J 3/46

(57) ABSTRACT

The present disclosure describes articles, systems, and methods for sensing and/or identifying objecting using color-dynamic, mechano-responsive photonic materials.

### RELATED APPLICATIONS

This application claims priority under 35 U.S.C. § 119(e) to U.S. Provisional Application No. 63/371,539, filed Aug. 16, 2022, and entitled “Deformation sensing and object identification with color-dynamic mechano-responsive photonic materials,” which is incorporated herein by reference in its entirety for all purposes.

### TECHNICAL FIELD

Object identifiers that include photonic materials and methods for identifying objects are generally described.

### BACKGROUND

There is a need to develop soft robots. This includes use of color-changing material as a soft sensor for robots. In particular, there is a need to produce color-changing soft skin robotic sensors. The sensors should have a low Young's modulus, a small footprint to not affect the robots' behavior, resilience and durability, and robustness. The material disclosed herein is a robot skin having these properties. Two applications for colorimetric sensing are disclosed herein: a soft multi-bistable metamaterial and a device for bottle selection and sorting.

### SUMMARY

This summary introduces a selection of concepts in simplified form that are described further below in the Detailed Description. One aspect of the disclosure herein is a material comprising a thin, soft black backing layer, optionally comprising DOWSIL™ 734, transparent, soft diffusion barrier layer, optionally comprising SOLARIS™, color changing photopolymer, and transparent, soft polymer layer, optionally comprising ECOFLEX™.

In some embodiments, the material is a color-dynamic, mechano-responsive, and photonic.

In some embodiments, a soft multi-bistable metamaterial comprising the material is described.

In some embodiments, a bottle recognition and sorting device comprising the material is described.

The subject matter of the present disclosure involves, in some cases, interrelated products, alternative solutions to a particular problem, and/or a plurality of different uses of one or more systems and/or articles.

In one aspect, disclosed are a series of sensors. In one set of embodiments, as sensor includes a photonic material having a plurality of refractive index variations, a backing layer adjacent to the photonic material, and an optical input directed towards the photonic material. The backing layer can be configured to absorb at least some visible light.

In another aspect, apparatus is provided, in one set of embodiments, this includes a photonic material having a plurality of refractive index variations, an adjacent backing layer, a blocking layer adjacent the photonic material, and a chamber adjacent to the blocking layer, where the chamber is configured to apply pressure to the blocking layer, the photonic material, and/or the backing layer.

In another aspect, disclosed are object recognition systems. In one set of embodiments, such a system includes a photonic material comprising a plurality of refractive index variations, an adjacent backing layer, a blocking layer adjacent to the photonic material, and an optical input directed towards the photonic material.

Another disclosed system is for identifying a target material, and includes a photonic material having a plurality of refractive index variations, where the target material is attached to the photonic material and includes a first set of features and a second set of features, and where wherein the photonic material is configured to identify a mechanical state of the target material.

In another aspect, disclosed are methods. One method is for identifying an object, and involves compressing the object within a chamber, applying a mechanical force to a photonic material adjacent to the chamber which induces reversible color variation in the photonic material, and detecting a change in color with an optical input.

In another embodiment, a method for identifying a mechanical state of a target material involves attaching a photonic material to the target material, applying a mechanical force to the photonic material, which induces reversible color variation in the photonic material, and determining a parameter of the target material based, at least in part, on the induced reversible color variation of the photonic material.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A schematically illustrates a sensor including a photonic material and a backing layer adjacent to the photonic material, according to some embodiments;

FIG. 1B is a schematic of a sensor including a photonic material, a backing layer adjacent to the photonic material, and an optical input directed towards the photonic material, according to some embodiments;

FIG. 1C is a schematic illustrating an object pressed against the sensor, according to some embodiments;

FIG. 1D is a schematic illustration of a sensor including a blocking layer, according to some embodiments;

FIG. 2A is a schematic of an apparatus including a chamber, according to some embodiments;

FIG. 2B is a schematic of the apparatus shown in FIG. 2A in which an objected is pressed against the sensor by a chamber, according to one set of embodiments;

FIG. 3A is a photographic image of a stretchable photonic material, according to some embodiments;

FIG. 3B is a photographic image of a robotic hand, according to some embodiments;

FIG. 3C shows materials used to fabricate a colorimetric sensor, according to some embodiments;

FIG. 3D shows a schematic of a color-changing sensor, according to some embodiments;

FIG. 3F shows some criteria considered in fabricating a sensor, according to some embodiments;

FIG. 3G shows some materials and Young's moduli for those materials for the sensor, according to some embodiments;

FIG. 3H show a series of photographic images illustrating additional sensor parameters, according to some embodiments;

FIG. 3I schematically depicts a spectroscopic analysis, according to some embodiments;

FIG. 3J shows a plot illustrating the persistence of color after 10,000 stretching cycles, according to some embodiments;

FIGS. 3K-3L show robustness considerations and measurements for the sensor, according to some embodiments;

FIG. 3M shows a series of photographic images that illustrate the stretchability of the material, according to some embodiments;

FIGS. 4A-4D depict a bottle recognition apparatus and system, according to some embodiments; and

FIGS. 4E-4F depict bottle identification using elevated labels on bottles, according to some embodiments.

### DETAILED DESCRIPTION

The following disclosure describes articles (e.g., sensors, apparatuses), systems, and methods for sensing deformed objects (e.g., mechanically deformed objects) and/or identifying objects based, at least in part, on the deformation of the object(s). As will be described in more detail below, the object may include or be associated with a photonic material, wherein the photonic material exhibits reversible color variation under applied mechanical force. The color variation indicates a mechanical state of the photonic material and may, in turn, provide information about the object (e.g., a mechanical state of the object, an identity of the object).

The Inventors have recognized and appreciated that a color-dynamic, elastomeric, mechano-responsive photonic material can be used to translate mechanical stimuli into optical readouts both visually (e.g., with the unaided eye) and/or optically, for example, via an optical input (e.g., a camera, a photodiode). The photonic material includes a plurality of refractive index variations, wherein the spacing of the refractive index variations can change upon the application of a mechanical stimuli. When coupled to an object, information about the mechanical state of the object can be derived from the photonic material. Because the photonic material is color-dynamic, a change in color of the photonic material (i.e., a change in electromagnetic radiation absorbed and/or reflected) indicates a mechanical state of the photonic material, and this change in color can be used to provide information about the associated object. In some cases, this allowed the photonic material to it act as a platform for sensor development, among other applications.

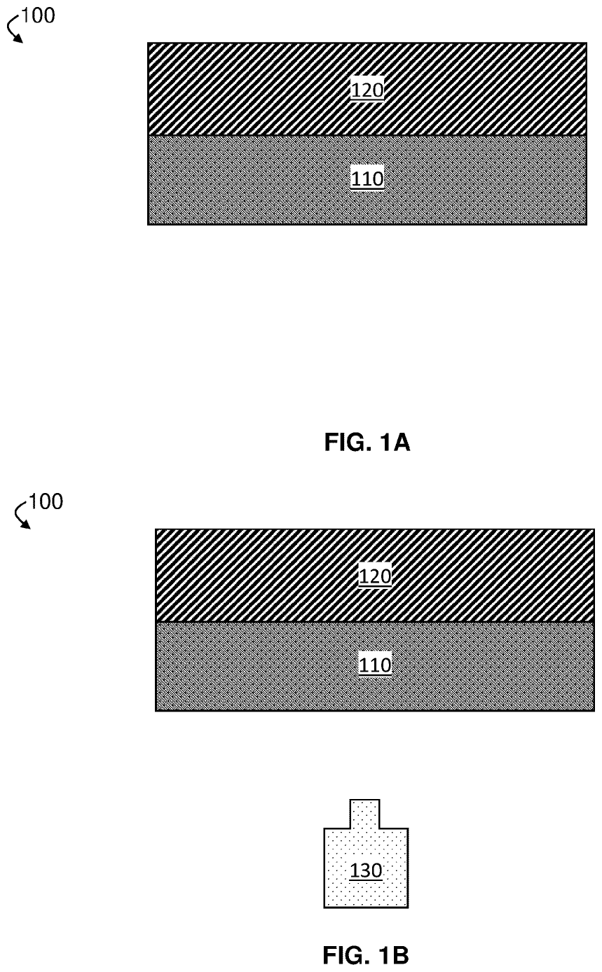

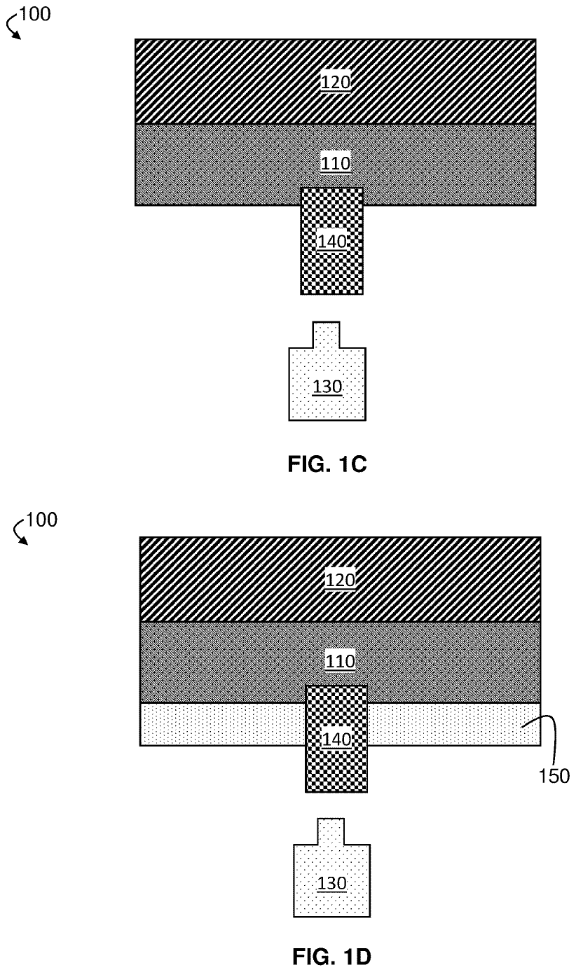

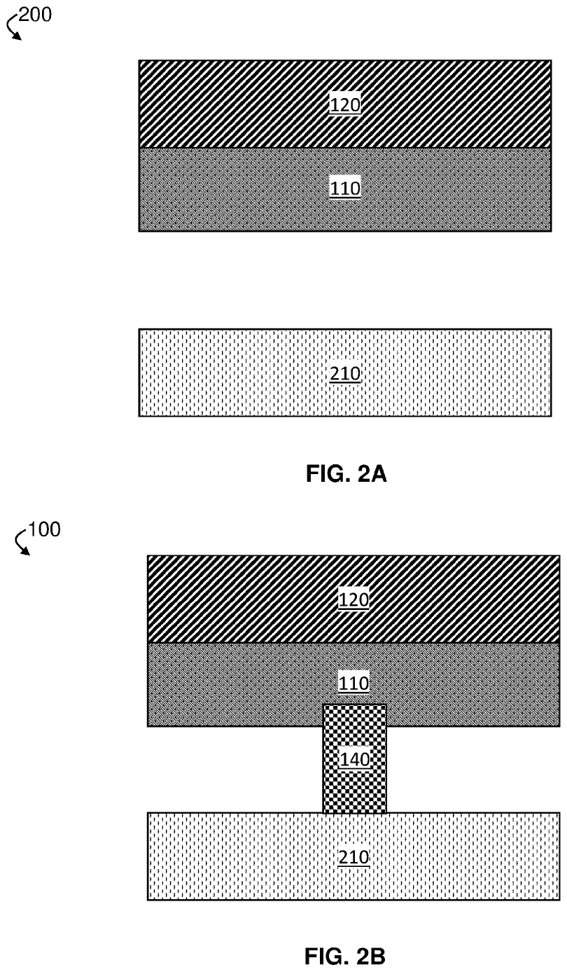

By way of illustration and not limitation, FIG. 1A illustrates a sensor, according to some embodiments. In FIG. 1A, a sensor 100 includes a photonic material 110 and a backing layer 120 adjacent to the photonic material. As described in more detail elsewhere herein, the backing layer can provide a color contrast with the photonic material, aiding in visualization. The sensor 100 may further comprise an optical input 130, such as a camera or fiber optic, which can provide information about the photonic material 100. An example of such an arrangement is shown in FIG. 1B.

When an object is pressed against the photonic material, the photonic material is compressed, stressed, or otherwise altered, which results in a change in configuration of the plurality of refractive index variations of the photonic material. For example, in FIG. 1C, an object 140 is pressed against the photonic material 110 of the sensor 110, such that it is mechanically deformed. Mechanical deformation of the photonic material 110 results in a color change (not shown) of the photonic material 100, which can be detected by the optical input 130. The optical input 130 can be associated with digital circuitry (e.g., a controller, a CPU, not shown in the figure), which may further aid providing information about the photonic material 110 and, in turn, information about the object 140.

In some embodiments, an additional layer is adjacent to the photonic layer and/or the backing layer. For example, in FIG. 1D, a blocking layer 150 is adjacent to the photonic layer 110. As described in more detail elsewhere herein, a blocking layer can prevent mixing or diffusion between the photonic material and another layer, such as the backing layer. However, it should be understood that other layers may be adjacent to photonic material and/or the backing layer, as this disclosure is not so limiting. In some embodiments, the blocking layer is transparent so that it does not inhibit viewing of color from the photonic layer. For example, in FIG. 1D, the blocking layer 150 is transparent so that the optical input 130 can view any color changes induced in the photonic material 110 by the object 140.

It will be understood, in view of this disclosure, that when a portion (e.g., a material, a layer, a region) is “on”, “adjacent”, “above”, “over”, “overlying”, or “supported by” another portion, it can be directly on the portion, or an intervening portion (e.g., another layer, structure, region) may also be present. Similarly, when a portion is “below” or “underneath” another portion, it can be directly below the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

For some embodiments, pressure is applied to the object such the object mechanically deforms against the photonic material. In some such embodiments, a chamber is provided to apply pressure to the object and the photonic material. For example, FIG. 2A shows an apparatus 200 that includes a photonic material 110 and a backing layer 120 and also includes a chamber 210. The chamber can provide a force against an object, causing it to mechanically deform the photonic material 110. By way of illustration, FIG. 2B provides a schematic illustration of the object 140 pressed against the photonic material 110 via the chamber 210.

Additional details about the articles, systems, and methods described herein are provided below.

In some embodiments, an article (e.g., a sensor, an apparatus) comprises a photonic material. The photonic material includes refractive index variations (e.g., microscale refractive index variations, nanoscale refractive index variations) that exhibit a change in color (or other electromagnetic radiation reflection/absorption) upon a mechanical deformation. In some embodiments, the photonic material comprises a photo-responsive elastomer optically patterned with refractive index variations.

In some embodiments, the refractive index variations comprise periodic variations of some characteristic or feature (e.g., height, width, thickness, material). Without wishing to be bound by any particular theory, one or more surfaces of the periodic variations may cause a partial reflection of incident light waves (e.g., an optical wave), and for light waves whose wavelengths are relatively close to the dimensions of the variations, the reflections may combine by constructive interference, such that the periodic variations act as distributed Bragg reflectors (DBR). When the dimensions of the variations are relatively close to the wavelengths of visible light (e.g., greater than or equal to 380 nm and less than or equal to 700 nm), the variations may act as an optical waveguide by reflecting certain optical waves while not reflecting certain other optical waves. As described in more detail below, the wavelengths of light that are reflected or not reflected may be tuned by the spacings of the refracted index variations.

The refractive index variations may have any suitable size or arrangement. For example, in some embodiments, the refractive index variations comprise gratings, grooves, and/or channels. In some embodiments, the refractive index variations comprise an array (e.g., a 1-D array, a 2-D array, a 3-D array) of periodic and/or repeating features. In some embodiments, the refractive index variations comprise an array of indentations and/or protrusions within the photonic material (e.g., within the photonic material, within a photo-responsive elastomer). In some embodiments, the photonic material comprises a plurality of voxels, wherein each voxel comprises a set of refractive index variations. In some embodiments, the refractive index variations comprise patterning, texturing, and/or roughening of a surface of the photonic material. Those skilled in the art in view of the present disclosure will be capable of selecting suitable sizes and arrangements of the refractive index variations.

The refractive index variations may have a regular or periodic characteristic dimension (e.g., a spacing between each variation, a period of the refractive index variations). In some embodiments, the refractive index variations are nanoscale refractive index variations. In some embodiments, the spacing between the refractive index variations is less than or equal to 1 μm, less than or equal to 900 nm, less than or equal to 800 nm, less than or equal to 750 nm, less than or equal to 700 nm, less than or equal to 650 nm, less than or equal to 650 nm, less than or equal to 550 nm, less than or equal to 500 nm, less than or equal to 400 nm, less than or equal to 300 nm, less than or equal to 200 nm, or less than or equal to 100 nm. In some embodiments, the spacing between the refractive index variations is greater than or equal to 100 nm, greater than or equal to 200 nm, greater than or equal to 300 nm, greater than or equal to 400 nm, greater than or equal or 500 nm, greater than or equal to 550 nm, greater than or equal to 600 nm, greater than or equal to 650 nm, greater than or equal to 700 nm, greater than or equal to 750 nm, greater than or equal to 800 nm, or greater than or equal to 900 nm. Combinations of the foregoing ranges are also possible (e.g., less than or equal to 1 μm and greater than or equal to 100 nm). Other ranges are possible as this disclosure is not so limited.

In some embodiments, the refractive index variations are microscale refractive index variations. In some embodiments, the spacing between the refractive index variations is less than or equal to 1 mm, less than or equal to 900 μm, less than or equal to 800 μm, less than or equal to 750 μm, less than or equal to 700 μm, less than or equal to 650 μm, less than or equal to 650 μm, less than or equal to 550 μm, less than or equal to 500 μm, less than or equal to 400 μm, less than or equal to 300 μm, less than or equal to 200 μm, or less than or equal to 100 μm. In some embodiments, the spacing between the refractive index variations is greater than or equal to 100 μm, greater than or equal to 200 μm, greater than or equal to 300 μum, greater than or equal to 400 μm, greater than or equal or 500 μm, greater than or equal to 550 μm, greater than or equal to 600 μm, greater than or equal to 650 μm, greater than or equal to 700 μm, greater than or equal to 750 μm, greater than or equal to 800 μm, or greater than or equal to 900 μm. Combinations of the foregoing ranges are also possible (e.g., less than or equal to 1 mm and greater than or equal to 100 μm). Other ranges are possible as this disclosure is not so limited.

In some embodiments, two or more sets of refractive index may be present within the photonic material. For example, the photonic material may comprise a first set of refractive index variations with a first characteristic dimension and a second set of refractive index variations. In some embodiments, the photonic material comprises a plurality of refractive index variations. In some embodiments, the photonic material comprises 2 sets, 3 sets, 4 sets, 5 sets, 6 sets, 7 sets, 8 sets, 9 sets, or 10 sets of refractive index variations. In some embodiments, the photonic material comprises 20 sets, 50 sets, 100 sets, or 1000 sets of refractive index features, each of which may occupy a sublayer (e.g., a 20^{th} sublayer, a 50^{th} sublayer, a 100^{th} sublayer, a 1000^{th} sublayer) of the photonic material. In some embodiments, the photonic material comprises a first set of refractive index variations and a second set of refractive index variations distinct from the first set of refractive index variations.

As mentioned above, the photonic materials described herein may be deformed or otherwise mechanically strained. In some embodiments, the mechanical deformation is reversible. That is, in some embodiments, the photonic material may have a first configuration (e.g., an original configuration, an initial configuration), where it may reflect electromagnetic radiation (i.e., light) with a first wavelength. In some embodiments, the photonic material may be, subsequently, mechanically deformed to a second configuration, where it may reflect electromagnetic radiation with a second wavelength, different from the first wavelength. In some embodiments, the photonic material may be returned to the first configuration, for example, when the mechanical strain is removed from the photonic material, where it may reflect electromagnetic radiation with the first wavelength. Mechanical strain includes, but is not limited to, pulling, stretching, bending, folding, twisting, compressing, rolling, and/or pressing. In some embodiments the photonic material exhibits reversible color variation under the applied mechanical strain. Details regarding color variation are described in more detail below.

In some embodiments, the photonic material has a particular Young's elastic modulus. For some embodiments, the photonic material has a Young's modulus of less than or equal to 10,000 kPa and greater than or equal to 1 kPa. In some embodiments, the Young's elastic modulus of the photonic material is less than or equal 10,000 kPa, less than or equal to 5,000 kPa, less than or equal to 2,000 kPa, less than or equal to 1,000 kPa, less than or equal to 500 kPa, less than or equal to 200 kPa, less than or equal to 100 kPa, less than or equal to 50 kPa, less than or equal to 25 kPa, less than or equal to 10 kPa, or less than or equal to 1 kPa. In some embodiments, the Young's elastic module of the photonic material is greater than or equal to 1 kPa, greater than or equal to 10 kPa, greater than or equal to 25 kPa, greater than or equal to 50 kPa, greater than or equal to 100 kPa, greater than or equal to 200 kPa, greater than or equal to 500 kPa, greater than or equal to 1,000 kPa, greater than or equal to 2,000 kPa, greater than or equal to 5,000 kPa, or greater than or equal to 10,000 kPa. Combinations of the above-referenced ranges are also possible (e.g., greater than or equal to 1 kPa and less than or equal to 10,000 kPa). Other ranges are possible. In some embodiments, an adjacent layer (e.g., a backing layer, a blocking layer) has a Young's elastic modulus to match the photonic material and can be within the above-referenced ranges.

The thickness of the photonic material may vary. In some embodiments, a thickness of the photonic material is less than or equal to 1 mm, less than or equal to 900 μm, less than or equal to 800 μm, less than or equal to 700 μm, less than or equal to 600 μm, less than or equal to 500 μm, less than or equal to 400 μm, less than or equal to 300 μm, less than or equal to 200 μm, or less than or equal to 100 μm. In some embodiments, the thickness of the photonic material is greater than or equal to 100 μm, greater than or equal to 200 μm, greater than or equal to 300 μm, greater than or equal to 400 μm, greater than or equal to 500 μm, greater than or equal to 600 μm, greater than or equal to 700 μm, greater than or equal to 800 μm, greater than or equal to 900 μm, or greater than or equal to 1 mm. Combinations of the above-referenced ranges are also possible (e.g., greater than or equal to 100 μm and less than or equal to 1 mm). Other ranges are possible.

As described above, in some embodiments, the photonic material may exhibit color variations when mechanically deformed. For example, in some embodiments, the photonic material may undergo a change in reflected color when the material is mechanically deformed. Without wishing to be bound by any particular theory, the photonic material may comprise refractive index variations of a particular arrangement, size, shape, and/or spacing such that incoming light is reflected with a particular color (i.e., with light of a particular wavelength), and upon deforming (e.g., stretching) the photonic material, the arrangement, size, shape and/or spacing of the refractive index variations may change such that the reflected light has a different color relative to the reflected light prior to deformation of the material. It is believed that deforming the photonic material may alter the spacing of the refractive index variations such that wavelength of reflected light is changed relative to a wavelength of reflected light in the undeformed photonic material with its original spacings of its refractive index variations.

In some embodiments, at least a portion of the photonic material may exhibit a first color. In some embodiments, at least a portion of the photonic material may be mechanically deformed and exhibit a second color. In some embodiments, the second color is different from the first color. In some embodiments, the photonic material may exhibit reversible color change such that the photonic material exhibits a first color when in the in a first configuration (e.g., a configuration in which the photonic material is not mechanically deformed), exhibits a second color when mechanically deformed to a second configuration different from the first configuration, and exhibits the first color when the mechanical deformation is removed.

Those of ordinary skill in the art would understand, based upon the teachings of this specification, that the reversible color change hall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. For example, in some embodiments, the reversible color change may not result in an exact return to the first color prior to deformation but should be interpreted as approximating the first color as defined mathematically, to an extent typically achievable and achieved for the recited fabrication technique as would be understood by those skilled in the art or as specifically described, Without wishing to be bound by theory, and solely for illustrative purposes, in an exemplary embodiment an applied deformation may at least partially irreversibly deform the photonic material such that, upon the release of the mechanical deformation, the photonic material does not return to it's original configuration but close to the first configuration. In some such embodiments, the color observed after removal of the mechanical deformation may approximate the first color, but not conform exactly to the same wavelength(s) observed prior to mechanical deformation.

In some embodiments, at least a portion of the photonic material may exhibit a first color. In some embodiments, at least a portion of the photonic material may be mechanically deformed and exhibit a second color. In some embodiments, the second color is different from the first color. In some embodiments, the photonic material may exhibit a color change such that the photonic material exhibits a first color when in the in a first configuration (e.g., a configuration in which the photonic material is not mechanically deformed), exhibits a second color when mechanically deformed to a second configuration different from the first configuration, and exhibits a third color when the mechanical deformation is removed, the third color being different than the

In some embodiments, different portions of the photonic material may exhibit a first color in a first portion of the photonic material and may exhibit a second color in a second portion of the photonic material. In some embodiments, the second color is different than the first color. In some embodiments, when the photonic material is mechanically deformed, the photonic material may exhibit a third color in the first portion of the photonic material and may exhibit a fourth color in the second portion, wherein the third color is different from the first color and/or the fourth color is different from second color. In some such embodiments, the color change may be reversible, such that upon removing the mechanical deformation (or otherwise returning the photonic material to its first or original configuration), the photonic material exhibits the first color at the first portion of the photonic material and exhibits the second color at the at the second portion of the photonic material.

In some embodiments, the photonic material may include a first portion that exhibits color change (e.g., reversible color change) upon mechanical deformation, while a second portion, different than the first portion, does not exhibit color change upon mechanical deformation. That is, in some embodiments, the photonic material may have a portion that exhibits color change when the material is stretched or otherwise mechanically deformed, while also having a portion that does not exhibit color change when the material is stretched or otherwise mechanically deformed.

In some embodiments, an image may be formed on or within the photonic material. In some such embodiments, the image is a color image and comprises a plurality of colors. In some embodiments, each position within the image (e.g., a pixel within the image, a voxel within the image) may each independently exhibit a first color, a first color of a first pixel being the same or different from a first color of a second pixel (or third pixel, or fourth pixel, etc.). In some embodiments, the photonic material may be mechanically deformed such that at least a portion of each position within the image each independently exhibits a second color different than first color. In some such embodiments, each position within the image may independently exhibit the first color when the mechanical deformation is removed, and the photonic material is returned to the state it was in prior to application of the mechanical deformation. In some embodiments, at least a portion of the pixels return to the first color after removal of the mechanical deformation (e.g., the photonic material returns to the first configuration). In some embodiments, substantially all of the pixels return to the first color after removal of the mechanical deformation (e.g., the photonic material returns to the first configuration). In some embodiments, at least a portion of the pixels maintain the second color after removal of the mechanical deformation (e.g., the photonic material returns to the first configuration). In some embodiments, a first plurality of pixels change color upon application of a mechanical deformation and a second plurality of pixels do not substantially change color upon application of the mechanical deformation.

In an illustrative embodiment, the photonic material may show a first image having a plurality of colors (e.g., each color represented by a pixel in the image) and, upon mechanical deformation of the photonic material, the photonic material shows a second image having a different plurality of colors than the first image.

In some embodiments, as described above, the photonic material is deformable. In some embodiments, the photonic material exhibits reversible color variation under applied mechanical strain. In some embodiments, the photonic material is capable of generating a color pattern or image. In some embodiments, the photonic material exhibits specular reflectance and/or diffuse reflectance. For embodiments in which the photonic material provides diffuse reflectance, these photonic materials may advantageously be perceived in a wider range of viewing angles and may also ensure a reduced dependency on illumination conditions by removing the image of the illuminating scene from the reflection and thereby providing more uniform color.

It should be understood that while various embodiments are described as undergoing color change or a color variation, any light (e.g., electromagnetic radiation) may undergo a change or variation (e.g., in wavelength) upon reflecting from the photonic materials described herein, and the embodiments are not limited to only color. As understood by those skilled in the art, color generally includes light within the visible light spectrum (e.g., approximately 380 nm to 700 nm), but the present disclosure is not limited to light only within this range, as any suitable wavelength of electromagnetic radiation may be capable of experiencing a change in wavelength upon interacting with the disclosed photonic materials in a deformed state relative to an undeformed state. For example, in some embodiments, the photonic material may reflect visible light (i.e., color) when in a first configuration (e.g., when the photonic material is in an undeformed state) and may reflect infrared light (i.e., non-visible light) upon deformation of the photonic material. Similarly, in some embodiments, the photonic material may reflect ultraviolet (i.e., non-visible light) when in a first configuration and may reflect blue light (i.e., visible light) upon deformation of the photonic material.

In some embodiments, the photonic material may reflect a portion of incident light, while also transmitting a portion of incident light. In some embodiments, at least 5%, at least 10%, at least 15%, at least 20%, at least 30%, at least 40%, or at least 50% of incident light is transmitted by the photonic material. In some embodiments, no greater than 50%, no greater than 40%, no greater than 30%, no greater than 20%, no greater than 10%, or no greater than 5% of incident light is transmitted by the photonic material. Combinations of the foregoing ranges are also possible (e.g., at least 5% and no greater than 20% of incident light is transmitted). Other ranges are possible. In some embodiments, the amount of reflect and/or transmitted light is defined or determined by the period of the refractive index variations (i.e., the refractive index variations may determine the wavelength or range of wavelengths reflected).

In some embodiments, the color observed for the photonic material is related to the amount of reflected light relative to the amount of transmitted light. For example, if the photonic material reflects red light, then it may transmit green and/or blue light and hence may appear teal. As another example, the photonic material may be deformed and the reflected light transitions from red to green to blue as the material is mechanically deformed and may then transmit light that transitions from teal to purple to yellow as the material is mechanically deformed. Of course, other color changes are possible, and those skilled in the art in view of the present disclosure will be capable of adjusting the relative amounts of transmitted and reflected light.

The observed color variations may be measured using a setup that comprises a tensile tester for measuring mechanical deformation, a spectrometer for measuring the wavelength of reflective light, and a microscope for visually observing the color variations of an image of the photonic material. Such a setup may allow the spectral reflectance of the photonic material to be measured as a function of applied strained. In some embodiments, the reflectance spectrum obtained may be mapped to a point in a color space (e.g., CIE 1931 color space) so that the observed color (or light) may be translated into color seen by an observer.

As noted above, in some embodiments, the observed change in color is reversible. For example, upon release of the mechanical deformation or applied stress, the color of the article may revert to the pre-deformed color. In some embodiments, the color may change from one or more colors in the visible light spectrum in a first configuration to one or more colors in the visible light spectrum in second configuration (e.g., from red to orange, from red to yellow, from red to green, from red to blue, from red to violet, from orange to red, from orange to yellow, from orange to green, from orange to blue, from orange to violet, from yellow to red, from yellow to orange, from yellow to green, from yellow to blue, from yellow to violet, from green to red, from green to orange, from green to yellow, from green to blue, from green to violet, from blue to red, from blue to orange, from blue to yellow, from blue to green, from blue to violet, from violet to red, from violet to orange, from violet to yellow, from violet to green, from violet to blue). Those of ordinary skill in the art would understand, based upon the teachings of this specification, that the first color and/or second color need not necessarily be in the visible light spectrum and may include ultraviolet, infrared, etc.

In some embodiments, the photonic material exhibits a change in observed color and/or wavelength by a certain amount when in a first configuration (e.g., an unstretched configuration) relative to a second configuration (e.g., a stretched configuration) upon application of a mechanical stress. For example, in some embodiments, the observed wavelength changes by greater than or equal to 0.5 nm, greater than or equal to 1 nm, greater than or equal to 5 nm, greater than or equal to 10 nm, greater than or equal to 20 nm, greater than or equal to 25 nm, greater than or equal to 50 nm, greater than or equal to 75 nm, greater than or equal to 100 nm, greater than or equal to 200 nm, greater than or equal to 300 nm, greater than or equal to 400 nm, or greater than or equal to 500 nm. In some embodiments, the observed wavelength changes by less than or equal to 500 nm, less than or equal to 400 nm, less than or equal to 300 nm, less than or equal to 200 nm, less than or equal to 100 nm, less than or equal to 75 nm, less than or equal to 50 nm, less than or equal to 25 nm, less than or equal to 20 nm, less than or equal to 10 nm, less than or equal to 5 nm, less than or equal to 1 nm, or less than or equal to 0.5 nm. Combinations of the above-referenced ranges are also possible (e.g., greater than or equal to 0.5 nm and less than or equal to 500 nm). Other ranges are possible. In some embodiments, the photonic material exhibits an increase in wavelength when in a first configuration relative to a second configuration (e.g., from 400 nm to 500 nm). In some embodiments, the photonic material exhibits a decrease in wavelength when in a first configuration relative to a second configuration (e.g., from 500 nm to 400 nm). -16 The color observed from the photonic material may include any type of electromagnetic radiation (i.e., electromagnetic radiation of any wavelength). Such electromagnetic radiation observed may include, but is not limited to, ultraviolet radiation (e.g., having a wavelength in a range from 10 nm to 380 nm), visible light (e.g., having a wavelength in a range from 380 nm to 740 nm), near-infrared radiation (e.g., having a wavelength in a range from 700 nm to 800 nm), and infrared radiation (e.g., having a wavelength in a range from 740 nm to 3 um).

For example, the wavelength(s) of light observed from the photonic material may comprise any suitable wavelength of electromagnetic radiation. In some embodiments, the light is monochromatic light of a single wavelength. In some embodiments, the light is polychromatic comprising two or more light waves of a different wavelengths. In some embodiments, the light observed from the photonic material comprises wavelengths greater than or equal to 250 nm, greater than or equal to 275 nm, greater than or equal to 300 nm, greater than or equal to 325 nm, greater than or equal to 350 nm, greater than or equal to 375 nm, greater than or equal to 400 nm, greater than or equal to 425 nm, greater than or equal to 450 nm, greater than or equal to 475 nm, greater than or equal to 500 nm, greater than or equal to 525 nm, greater than or equal to 550 nm, greater than or equal to 575 nm, greater than or equal to 600 nm, greater than or equal to 625 nm, greater than or equal to 650 nm, greater than or equal to 675 nm, greater than or equal to 700 nm, greater than or equal to 725 nm, greater than or equal to 750 nm, greater than or equal to 775 nm, or greater than or equal 800 nm. In some embodiments, the light observed from the photonic material comprises wavelengths less than or equal to 800 nm, less than or equal to 775 nm, less than or equal to 750 nm, less than or equal to 725 nm, less than or equal to 700 nm, less than or equal to 675 nm, less than or equal to 650 nm, less than or equal to 625 nm, less than or equal to 600 nm, less than or equal to 575 nm, less than or equal to 550 nm, less than or equal to 525 nm, less than or equal to 500 nm, less than or equal to 475 nm, less than or equal to 450 nm, less than or equal to 425 nm, less than or equal to 400 nm, less than or equal 375 nm, less than or equal to 350 nm, less than or equal to 325 nm, less than or equal to 300 nm, less than or equal to 275 nm, or less than or equal to 250 nm. Combinations of the foregoing ranges are also possible (e.g., greater than or equal to 250 nm and less than or equal to 800 nm). Other ranges are possible. In some embodiments, the light observed from the photonic material comprises two or more ranges selected from the above-referenced ranges of electromagnetic radiation.

In some embodiments, the light observed from the photonic material comprises broadband radiation. In certain instances, the light observed from the photonic material comprises a wavelength range spanning at least 350 nm, at least 360 nm, at least 370 nm, at least 380 nm, at least 390 nm, at least 400 nm, at least 500 nm, at least 1 μm, at least 2 μm, or at least 3 μm. In certain instances, the source of electromagnetic radiation is configured to emit electromagnetic radiation in a wavelength range spanning 350 nm to 400 nm, 350 nm to 500 nm, 350 nm to 1 μm, 350 nm to 2 μm, 350 nm to 3 μm, 400 nm to 500 nm, 400 nm to 1 μm, 400 nm to 2 μm, 400 nm to 3 μm, 500 nm to 1 μm, 500 nm to 2 μm, 500 nm to 3 μm, 1 μm to 2 μm, or 1 μm to 3 μm.

In some embodiments, the light observed from the photonic material comprises a wavelength range spanning at least 350 nm, at least 360 nm, at least 370 nm, at least 380 nm, at least 390 nm, at least 400 nm, at least 500 nm, at least 600 nm, at least 700 nm, or at least 800 nm. In certain instances, the light observed from the photonic material comprises a wavelength range of greater than or equal to 350 nm, greater than or equal to 400 nm, greater than or equal to 450 nm, greater than or equal to 500 nm, greater than or equal to 550 nm, greater than or equal to 600 nm, greater than or equal to 650 nm, greater than or equal to 700 nm, or greater than or equal to 750 nm and less than or equal to 800 nm, less than or equal to 750 nm, less than or equal to 700 nm, less than or equal to 650 nm, less than or equal to 600 nm, less than or equal to 550 nm, less than or equal to 500 nm, less than or equal to 450 nm, or less than or equal to 400 nm. Combinations of the above referenced ranges are also possible (e.g., greater than or equal to 350 nm and less than or equal to 800 nm). Other ranges are also possible.

In some embodiments, the light observed from the photonic material comprises relatively narrow ranges of wavelengths. In some embodiments, the light observed from the photonic material comprises a discrete wavelength range spanning 350 nm or less, 300 nm or less, 200 nm or less, 100 nm or less, 90 nm or less, 80 nm or less, 70 nm or less, 60 nm or less, 50 nm or less, 40 nm or less, 30 nm or less, 20 nm or less, or 10 nm or less. In some embodiments, the light observed from the photonic material comprises a discrete wavelength range spanning 10 nm to 20 nm, 10 nm to 40 nm, 10 nm to 50 nm, 10 nm to 60 nm, 10 nm to 80 nm, 10 nm to 100 nm, 10 nm to 200 nm, 10 nm to 300 nm, 10 nm to 350 nm, 20 nm to 40 nm, 20 nm to 50 nm, 20 nm to 60 nm, 20 nm to 80 nm, 20 nm to 100 nm, 20 nm to 200 nm, 20 nm to 300 nm, 20 nm to 350 nm, 40 nm to 60 nm, 40 nm to 80 nm, 40 nm to 100 nm, 40 nm to 200 nm, 40 nm to 300 nm, 40 nm to 350 nm, 50 nm to 100 nm, 50 nm to 200 nm, 50 nm to 300 nm, 50 nm to 350 nm, 100 nm to 200 nm, 100 nm to 300 nm, or 100 nm to 350 nm.

In some embodiments, the light observed from the photonic material comprises a discrete wavelength range spanning 500 nm or less, 400 nm or less, 350 nm or less, 300 nm or less, 200 nm or less, 100 nm or less, 90 nm or less, 80 nm or less, 70 nm or less, 60 nm or less, 50 nm or less, 40 nm or less, 30 nm or less, 20 nm or less, or 200 nm or less. In some embodiments, the light observed from the photonic material comprises a discrete wavelength range spanning 200 nm to 20 nm, 200 nm to 40 nm, 200 nm to 50 nm, 200 nm to 60 nm, 200 nm to 80 nm, 200 nm to 100 nm, 200 nm to 200 nm, 200 nm to 300 nm, 200 nm to 350 nm, 20 nm to 40 nm, 20 nm to 50 nm, 20 nm to 60 nm, 20 nm to 80 nm, 20 nm to 100 nm, 20 nm to 200 nm, 20 nm to 300 nm, 20 nm to 350 nm, 40 nm to 60 nm, 40 nm to 80 nm, 40 nm to 100 nm, 40 nm to 200 nm, 40 nm to 300 nm, 40 nm to 350 nm, 50 nm to 100 nm, 50 nm to 200 nm, 50 nm to 300 nm, 50 nm to 350 nm, 100 nm to 200 nm, 100 nm to 300 nm, or 100 nm to 500 nm.

In some embodiments, the light observed from the photonic material comprises wavelengths of violet light (e.g., light having a peak wavelength in a range of 400 nm to 450 nm), blue light (e.g., light having a peak wavelength in a range from 450 nm to 490 nm), cyan light (e.g., light having a peak wavelength in a range from 490 nm to 520 nm), green light (e.g., light having a peak wavelength in a range from 520 nm to 560 nm), yellow light (e.g., light having a peak wavelength in a range from 560 nm to 590 nm), orange light (e.g., light having a peak wavelength in a range from 590 nm to 635 nm), red light (e.g., light having a peak wavelength in a range from 635 nm to 700 nm), or combinations thereof. In some embodiments, the light observed from the photonic material comprises wavelengths in a plurality of relatively narrow ranges of wavelengths. In certain instances, the source of electromagnetic radiation is configured to emit electromagnetic radiation in at least 2 discrete ranges, at least 3 discrete ranges, at least 4 discrete ranges, or at least 5 discrete ranges.

In some embodiments, the light observed from the photonic material comprises wavelengths having at least a first portion of the electromagnetic radiation spectrum and a second portion of the electromagnetic radiation spectrum, each selected from the one or

In some embodiments, the light observed from the photonic material is different at various locations across a surface of the photonic material. For example, in some embodiments, a first portion of the surface of the photonic material is observed to have a first wavelength(s) of electromagnetic radiation and a second portion of the surface of the photonic material is observed to have a second wavelength(s) of electromagnetic radiation, different than the first wavelength(s) of electromagnetic radiation, for a given configuration of the photonic material.

The photonic material may include a photopolymer layer. In some embodiments, the photopolymer layer may comprise a photopolymeric material. Any suitable photopolymeric material may be used. The photopolymeric material may include a photoiniator, a monomer, and/or oligomer, and the photoiniator may tune polymerization of the monomers and/or the oligomers of the photopolymeric material upon exposure to photons (i.e., light). Non-limiting examples of photopolymeric materials include epoxides, urethanes, ethers (e.g., polyethers), or esters (e.g., polyesters), methacrylic acid, hydroxyethyl acrylate, hydroxyethyl methacrylate, hydroxypropyl methacrylate, isodecyl acrylate, polyacrylamides, N-vinyl pyrrolidone, trimethylolpropane triacrylate (TMPTA), ethoxylated TMPTA, trimethylolpropane trimethacrylate, hexanediol diacrylatebenzophenone, xanthones, and quinones. In some embodiments, the photopolymeric material comprises an elastomer. In some embodiments, the photopolymer layer comprises a photo-responsive elastomer. In some embodiments, the photopolymeric material comprises a holographic recording material. In some embodiments, the photopolymer layer comprises two or more sublayers, and each layer may contain a distinct photopolymeric material. By way of example, a photopolymer layer may comprise three sublayers, where a first sublayer may react to red light, a second sublayer that may react with blue light, a third sublayer that may react with green light. In some embodiments, the photopolymer comprises a holographic material, such as material comprising a silver halide emulsion. In some embodiments, the photopolymer layer comprises a polycarbonate polymeric material, such as Bayfol® HX films. Other materials are possible.

In some embodiments, the photonic material comprises an elastomer.

Various embodiments may also include a backing layer. The backing layer may, for example, provide a color contrast with the photonic layer, making it easier to image the color. Of course, the backing layer may also provide other benefits, such as providing a substrate for the photonic material and/or providing stretchability to articles (e.g., sensors) including the backing layer.

In some embodiments, a backing layer is adjacent to the photonic material. The backing layer may further tune the physical and/or optical properties of the photonic material, such as light filtering, enhancing saturation of the reflected colors, and supporting the stretchability of the photonic material (e.g., comprising a photopolymer). Advantageously, the backing layer may also tune or enhance the color-changing properties of the photonic material, for example, by modifying properties of electromagnetic radiation transmitting and/or reflecting from the photonic material. In some embodiments, the backing layer is deformable (e.g., reversibly deformable) and/or is configured to mechanically deform in tandem with the photonic material. For some embodiments, the photonic material may have an image on a surface of the layer (e.g., a front surface of the photonic material), in which case the backing surface may be positioned on a side opposite the image (i.e., on a back surface of the photonic material). In some embodiments, the backing layer may reflect or is configured to reflect at least a portion of incident light (e.g., light transmitted through the photonic material). In some embodiments, at least 50%, at least 60%, at least 70%, at least 80%, at least 90%, at least 99%, or at least 99.99% of incident light is reflected by the backing layer. In some embodiments, no greater than 99.9%, no greater than 99%, no greater than 90%, no greater than 80%, no greater than 70%, no greater than 60%, no or greater than 50% of incident light is reflected by the backing layer. Combinations of the foregoing ranges are also possible (e.g., greater than or equal to 50% and less than or equal to 95% of light is reflected by the backing layer). Other ranges are possible. In some embodiments, the backing layer may reflect light while in a mechanically undeformed configuration and/or in a deformed configuration.

In some embodiments, the backing layer may transmit incident light (e.g., light passing through from the photonic material to the backing layer). In some embodiments, the backing layer may reflect at least some incident light and transmit at least some incident light. In some embodiments, at least 1%, at least 5%, at least 10%, at least 25%, at least 50%, at least 75%, at least 95%, at least 99%, or at least 99.99% of incident light is transmitted through the backing layer. In some embodiments, the backing layer is transparent, such that all incident light is transmitted through the backing layer (i.e., 100% of incident light is transmitted through the backing layer). In some embodiments, no greater than 99.99%, no greater than 99%, no greater than 95%, no greater than 75%, no greater than 50%, no greater than 25%, or no greater than 10%, no greater than 5%, or no greater than 1% of incident light is transmitted through backing layer. Combinations of the above-referenced ranges are also possible (e.g., at least 1% of incident light and no greater than 95% of incident light is transmitted through the backing layer). Other ranges are possible. In some embodiments, the backing layer is opaque, such that no incident light is transmitted through the backing layer (i.e., 0% of incident light is transmitted through the backing layer). In some embodiments, the backing layer may transmit and/or reflect light in a mechanically undeformed configuration and/or a mechanically deformed configuration.

In some embodiments, the backing layer may absorb at least a portion of incident light. In some embodiments, at least 5%, at least 10%, at least 15%, at least 20%, at least 25%, or at least 50% of incident light is absorbed by the backing layer. In some embodiments, no greater than 50%, no greater than 25%, no greater than 20%, no greater than 15%, no greater than 10%, or no greater than 5% of incident light is absorbed by the backing layer. Combinations of the foregoing ranges are also possible (e.g., at least 5% and no greater than 50% of incident light is absorbed by the backing layer). Other ranges are possible.

The backing layer may be of any suitable material. In some embodiments, the backing layer comprises a polymeric material such as silicones, polyurethanes, isoprene and isoprene-derivatives, thermoplastics, and thermoplastic elastomers, as non-limiting examples. In some embodiments, the backing layer comprises silicone (e.g., black silicone). In some embodiments, the backing layer comprises a non-transparent pigment. In some embodiments, the backing layer is black. In some embodiments, the backing layer comprises an elastomer. In some embodiments, the backing layer comprises silicone, polyurethane, natural polyisoprene, and/or synthetic polyisoprene. In some embodiments, the mechanical properties of the article are generally related to the mechanical properties of the backing layer. For example, the overall elasticity of the photonic material may be related to the elasticity of the backing layer. However, in other embodiments, the mechanical properties of the article are not related to the mechanical properties of the backing layer.

In some embodiments, the backing layer has a particular Young's elastic modulus. For example, for some embodiments, backing layer has a Young's modulus of less than or equal to 10,000 kPa and greater than or equal to 1 kPa. In some embodiments, the elastic modulus of the backing layer is less than or equal to 5 GPa, less than or equal to 3 GPa, less than or equal to 1 GPa, less than or equal to 750 MPa, less than or equal to 500 MPa, less than or equal to 250 MPa, less than or equal 100 MPa, less than or equal to 75 MPa, less than or equal to 50 MPa, less than or equal to 25 MPa, less than or equal to 10 MPa, less than or equal to 5 MPa, less than or equal to 1 MPa, less than or equal to 750 kPa, less than or equal to 500 kPa, less than or equal to 250 kPa, less than or equal to 100 kPa, less than or equal to 75 kPa, less than or equal to 50 kPa, less than or equal to 25 kPa, or less than or equal to 10 kPa. In some embodiment, the elastic modulus of the backing layer is greater than or equal to 10 kPa, greater than or equal to 25 kPa, greater than or equal to 50 kPa, greater than or equal to 75 kPa, greater than or equal to 100 kPa, greater than or equal to 250 kPa, greater than or equal to 500 kPa, greater than or equal to 750 kPa, greater than or equal to 1 MPa, greater than or equal to 5 MPa, greater than or equal to 10 MPa, greater than or equal to 25 MPa, greater than or equal to 50 MPa, greater than or equal to 75 MPa, greater than or equal to 100 MPa, greater than or equal to 250 MPa, greater than or equal to 500 MPa, greater than or equal to 750 MPa, greater than or equal to 1 GPa, greater than or equal to 3 GPa, or greater than or equal to 1 GPa. Combinations of the foregoing ranges are also possible (e.g., greater than or equal to 10 kPa and less than or equal to 5 GPa). Other ranges are possible.

In some embodiments, the backing layer may have a different elasticity relative to the photonic material. In some embodiments, the Young's modulus of the backing layer is at least 1 times greater, 1.1 times greater, 1.2 times greater, 1.5 times greater, 2 times greater, 3 times greater 4 times greater, 5 times greater, 10 times greater, 20 times greater 50 times greater, 75 times greater 100 times greater, 500 times greater, 1000 times greater, or more than the Young's modulus of the photonic material. In some embodiments, the Young's modulus of the photonic material is at least 1 times greater, 1.1 times greater, 1.2 times greater, 1.5 times greater, 2 times greater, 3 times greater 4 times greater, 5 times greater, 10 times greater, 20 times greater, 50 times greater, 75 times greater, 100 times greater, 500 times greater, 1000 times greater or more than the Young's modulus of the backing layer.

The backing layer may have any suitable thickness. In some embodiments, a thickness of the backing layer is less than or equal to 1 mm, less than or equal to 900 μm, less than or equal to 800 μm, less than or equal to 700 μm, less than or equal to 600 μm, less than or equal to 500 μm, less than or equal to 400 μm, less than or equal to 300 μm, less than or equal to 200 μm, or less than or equal to 100 μm. In some embodiments, the thickness of the backing layer is greater than or equal to 100 μm, greater than or equal to 200 μm, greater than or equal to 300 μm, greater than or equal to 400 μm, greater than or equal to 500 μm, greater than or equal to 600 μm, greater than or equal to 700 μm, greater than or equal to 800 μm, greater than or equal to 900 μm, or greater than or equal to 1 mm. Combinations of the above-referenced ranges are also possible (e.g., greater than or equal to 100 μm and less than or equal to 1 mm). Other ranges are possible.

Various embodiments described herein may further include a blocking layer. In some such embodiments, the blocking layer may reduce, block, or otherwise mitigate diffusion between others layers. For example, the blocking layer is capable of and/or configured to block diffusion between the photonic material and a backing layer. Advantageously, the blocking layer may allow the photonic material to maintain its reversible color-changing properties relative to if no blocking layer was present.

In some embodiments, the blocking layer is capable of reducing diffusion between the photonic material and the backing layer. In some embodiments, the blocking layer is a diffusion-blocking layer.

In some embodiments, the blocking layer is transparent (e.g., transparent to visible light).

The blocking layer may have any suitable thickness. In some embodiments, a thickness of the blocking layer is less than or equal to 1 mm, less than or equal to 900 μm, less than or equal to 800 μm, less than or equal to 700 μm, less than or equal to 600 μm, less than or equal to 500 μm, less than or equal to 400 μm, less than or equal to 300 μm, less than or equal to 200 μm, or less than or equal to 100 μm. In some embodiments, the thickness of the blocking layer is greater than or equal to 100 μm, greater than or equal to 200 μm, greater than or equal to 300 μm, greater than or equal to 400 μm, greater than or equal to 500 μm, greater than or equal to 600 μm, greater than or equal to 700 μum, greater than or equal to 800 μm, greater than or equal to 900 μm, or greater than or equal to 1 mm. Combinations of the above-referenced ranges are also possible (e.g., greater than or equal to 100 μm and less than or equal to 1 mm). Other ranges are

In some embodiments, an optical input is also present. The optical input is configured to receive light (e.g., color, visible light) and convert this data into electronic information, which may be further processed (e.g., by a controller). In one embodiment, the optical input is a fiber optic cable. In some embodiments, the optical input includes a plurality of fiber optic cables. In some embodiments, the optical input comprises a fiber optic cable, a camera, and/or a microscope. Other optical inputs are possible (e.g., lasers, photodiode arrays) as this disclosure is not so limited.

Various embodiments may include a chamber for providing pressure to the photonic material (e.g., an object pressed against by the photonic material by the chamber). Accordingly, in some embodiments, the chamber is adjacent to the blocking layer, wherein the chamber is configured to apply pressure to an object, blocking layer, the photonic material, and/or the backing layer.

The chamber can be associated or otherwise operatively coupled with a gas source (e.g., a compressed air line, a gas cylinder), which can provide pressure to an adjacent component (e.g., an object, a blocking layer, a photonic material). In some embodiments, the chamber is an air chamber configured to receive compressed air.

In some embodiments, a grip is included, which may hold an object (e.g., as a pressure is applied to the object). The grip may be functionalized with a sensor (e.g., a photonic material, a backing layer) such that the grip provides pressure to the object, either alone, or independently of the chamber.

The articles, system, and methods described herein are suitable for a variety of applications. For various embodiments, the articles, systems, and methods can be used to identify an object. In some such cases, the object comprises an identifiable topography, for example, the topography comprises a first surface and a second surface elevated relative to the first surface, such that these two surfaces cause a different mechanical deformation in the photonic material that can be identified (e.g., by an optical input). As another application, in some embodiments, a sensor can be used for soft robotic. In another application, a photonic material can be integrated into ring gripper that is used to visualize labels on glass bottles, which demonstrates its utility for automated sorting and/or recycling bottles, and other objects. In some embodiments, a reliable recognition system based on color-dynamic photonic materials integrated with a robotic sorting system can reduce the amount of manual labor needed in sorting and/or manufacturing. In some applications, the articles, system, and methods can be used to monitor the deformation state of a material (e.g., a target material), such as a mechanical metamaterial. For example, in some such embodiments, the metamaterial is composed of an array of features (e.g., holes of two distinct sizes arranged in a regular pattern). The color dynamic material is applied over the metamaterial and allows a user to visually assess the deformation state of each individual hole when the metamaterial is subjected to mechanical deformation. Of course, other applications are possible and those skilled in the art, in view of this disclosure, will understand how to adapt the various articles, system, and methods for a variety of object identification and/or sensing applications.

A variety of objects can be identified. In some embodiments, the object to be identified is a bottle. In some embodiments, the object to be identified is selected from a recyclable object, a manufactured object, a consumer good, a food object, and/or clothing.

In some embodiments, a method for identifying the object includes compressing the object within a chamber, applying a mechanical force to a photonic material adjacent to the chamber, wherein applying the mechanical force induces reversible color variation in the photonic material, and detecting a change in color with an optical input.

In some embodiments, one or more objects can be identified. That is, in some embodiments, the object is a first object, and the method further comprises compressing a second object within the chamber similar to the first object, and the second object can be identified. In some embodiments, additional objects can be further identified (e.g., a third object, a fourth object, a fifth object, and so forth). In some embodiments, a mixture of objects can be identified and/or sorted (e.g., sorting bottles from cans).

In some embodiments, the photonic materials may be used to identify a mechanical state of another material (e.g., a target material). This may include, for example, attaching a photonic material to the target material, applying a mechanical force to the photonic material, wherein applying the mechanical force induces reversible color variation in the photonic material, and determining a parameter of the target material based, at least in part, on the induced reversible color variation of the photonic material. This may be particularly advantageous for metamaterials that comprise a first set of features, such a first set of pores or cells, and a second set of features distinct from the first set of features, such as a second set of pores or cells. The first set of features can have a first mechanical state and the second set of features can have a second mechanical state, and the photonic material can be used to identify which state one or more features are presently in.

When identifying a target material (e.g., a metamaterial), a system may include a photonic material comprising a plurality of refractive index variations and the target material attached to the photonic material, wherein the target material comprises a first set of features and a second set of features, wherein the photonic material is configured to identify a mechanical state of the target material. In some embodiments, the target material comprises nanometer-scale features, micrometer-scale features, millimeter-scale features, scale-centimeter features, and/or meter-scale features. The system may further comprise a second photonic material, wherein target material is between the first photonic material and the second photonic material.

In some embodiments, a material comprising a thin, soft black backing layer, optionally comprising DOWSIL™ 734, transparent, soft diffusion barrier layer, optionally comprising SOLARIS™, color changing photopolymer; and transparent, soft polymer layer, optionally comprising ECOFLEX™, wherein the material is a color-dynamic, mechano-responsive, and photonic is described.

The following examples are intended to illustrate certain embodiments of the present invention, but do not exemplify the full scope of the invention.

### Example 1

The following example describes sensor verification using photonic materials that exhibit reversible color variation under applies stress.

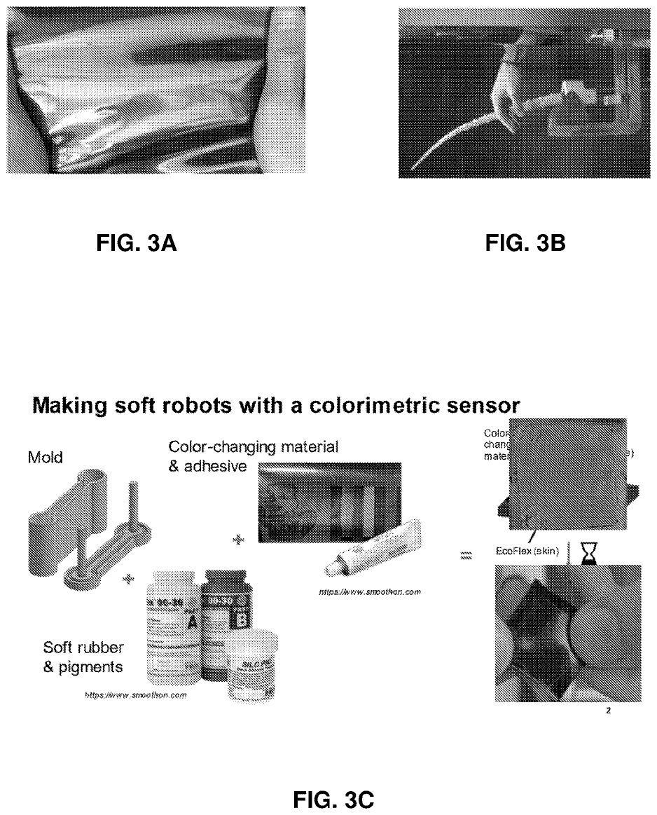

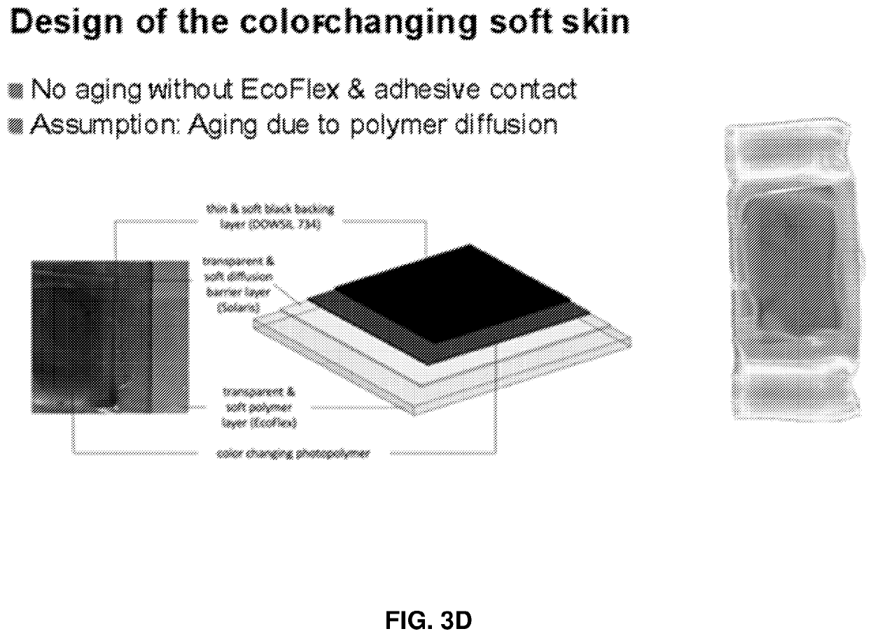

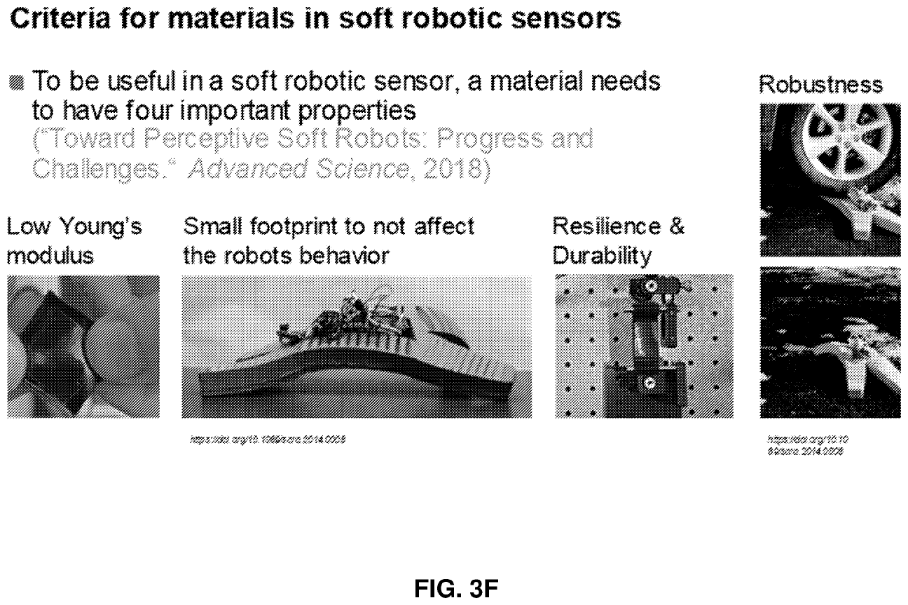

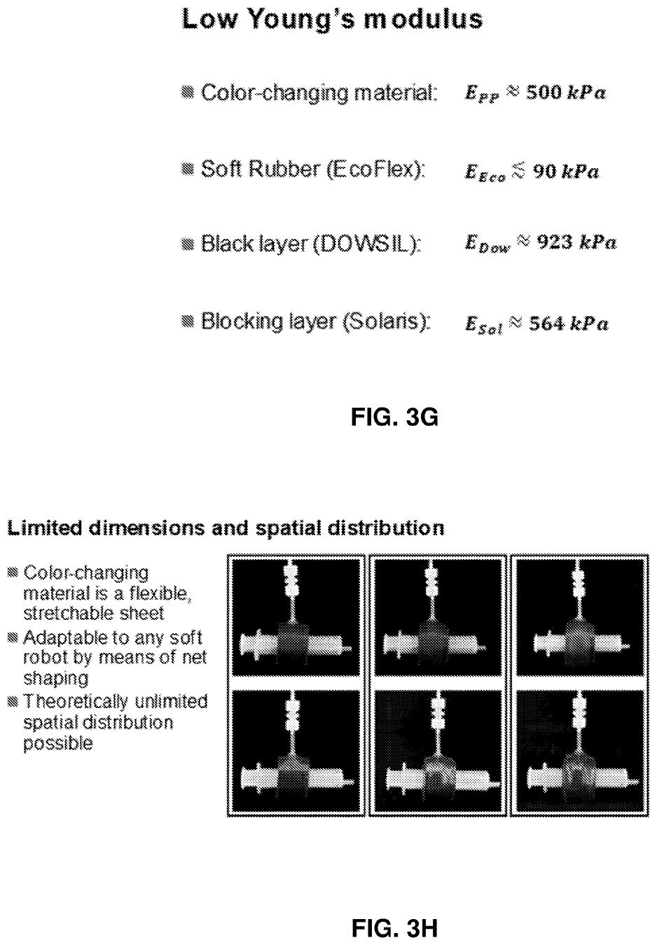

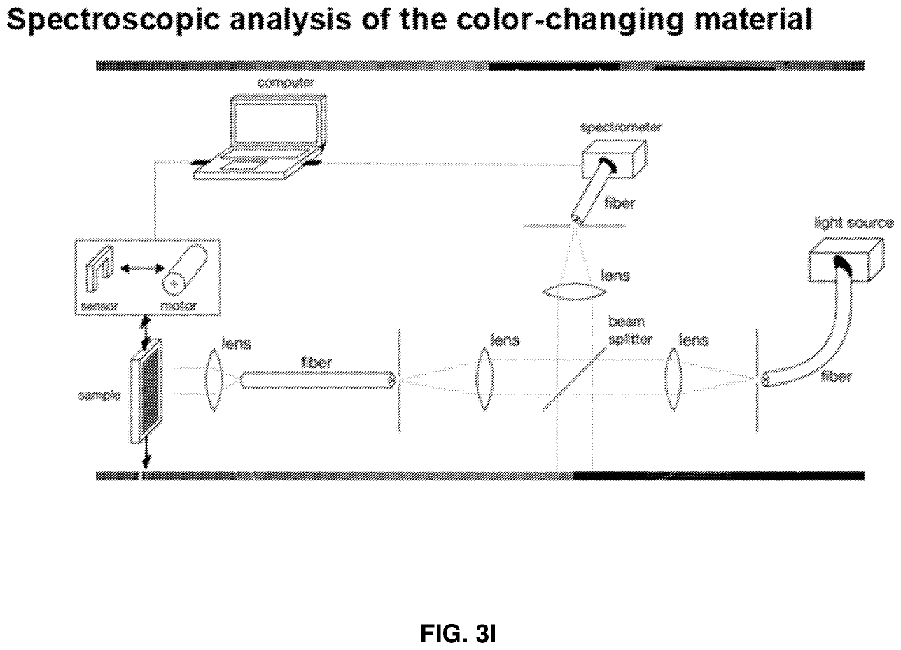

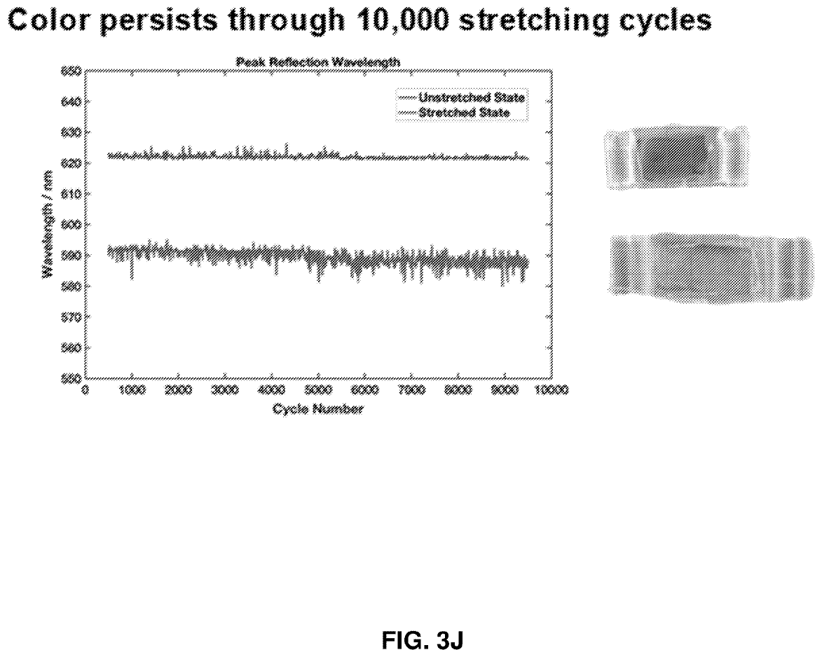

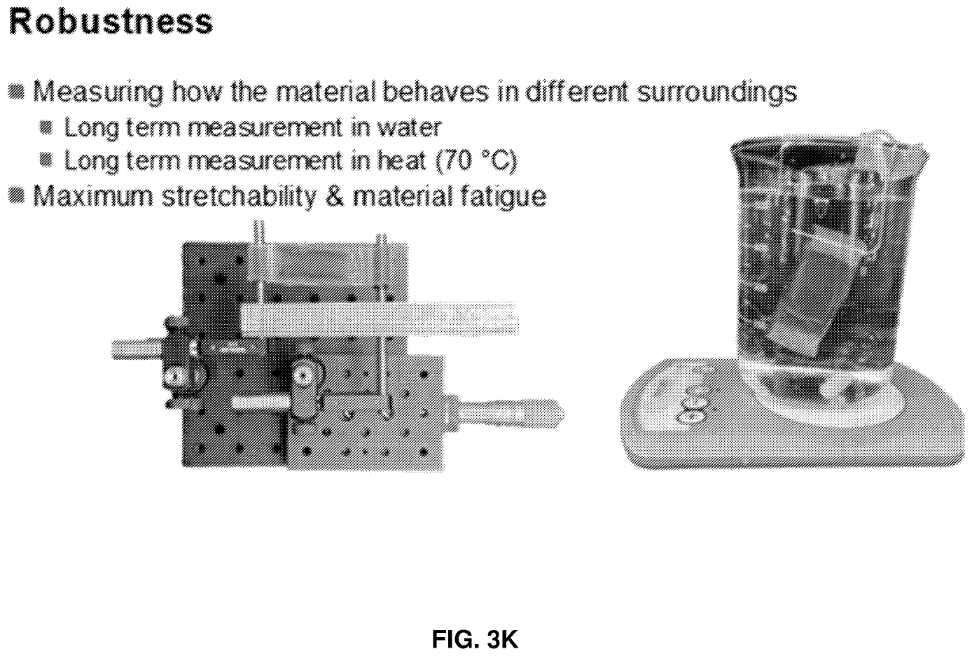

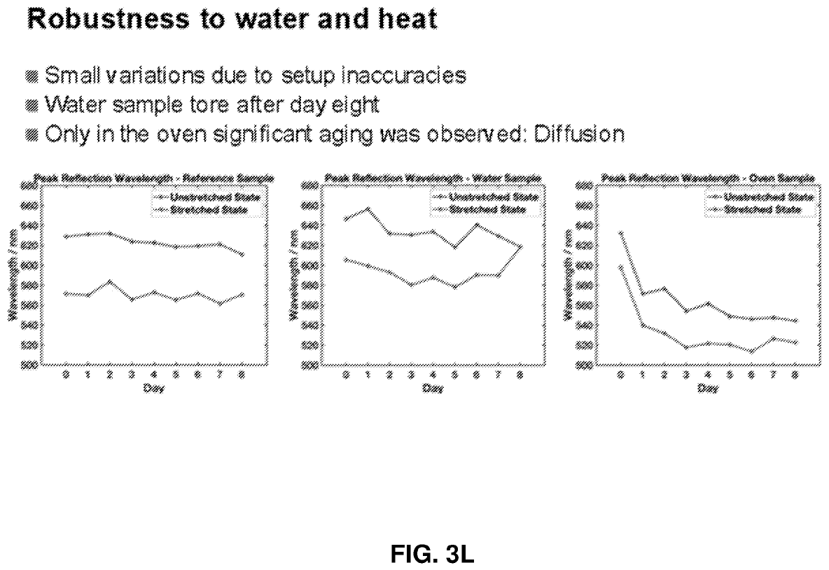

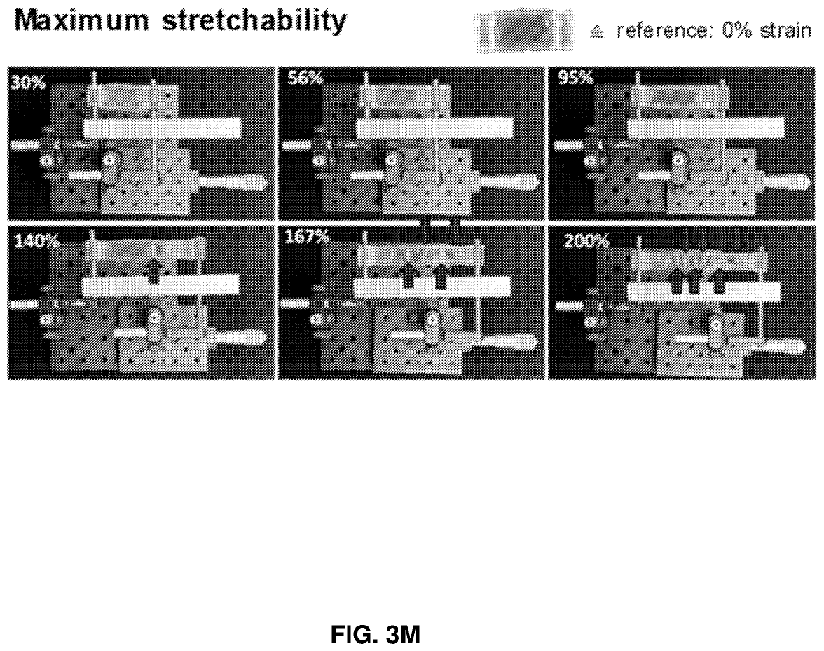

FIG. 3A is a photographic image of a stretchable photonic material. While not shown in the figure, upon stretching, the photonic material exhibits reversible color variation. This provided motivation that photonic material might be used as a soft sensor, such as for the robotic hand illustrated in the photographic image of FIG. 3B. As an example, soft robots could be fabricated with colorimetric sensors, for example, by using the materials shown in FIG. 3C.

FIG. 3D shows one application of the sensor as “soft skin” for a mechanical report. The soft skin including a color changing photopolymer photonic material, a black backing layer, a diffusion blocking layer, along with an additional transparent layer.

FIG. 3F illustrates some criteria that were considered in fabricating the soft sensors. For example, a relatively low Young's modulus, a small footprint that does not affect the behavior of the sensor (e.g., if the sensor is attached to a robot, it does not impede the function of the robot), resilience & durability, along with robustness were considered. FIG. 3G provides more details regarding the Young's moduli that were considered. FIG. 3H provides further considerations for sensors, such as the flexibility of the photonic material, the adaptability of the object to be sensed, and its spatial distribution, as an example.

FIG. 3I details how the described sensor can be including in an overall system for analysis using a photospectrometer and FIG. 3J shows that the color of the sensor (illustrated by the wavelength in the y-axis) persisted through at least 10,000 stretching cycles.

The robustness of the sensor was determined by measuring how the material behaves in different surroundings. For example, as shown in FIG. 3K and FIG. 3L, the robustness of the sensor could be measured in water and/or heat, by immersing the sensor in heated water and measuring the wavelength of emission of the unstretched and stretched photonic material of the sensor over time.

The stretchability of the sensor could also be measured. For example, as shown in FIG. 3M, the stretchability of the sensor was measured relative to the unstrained sensor.

### Example 2

The following example describes a system and an apparatus for identifying bottles, as one type of object.

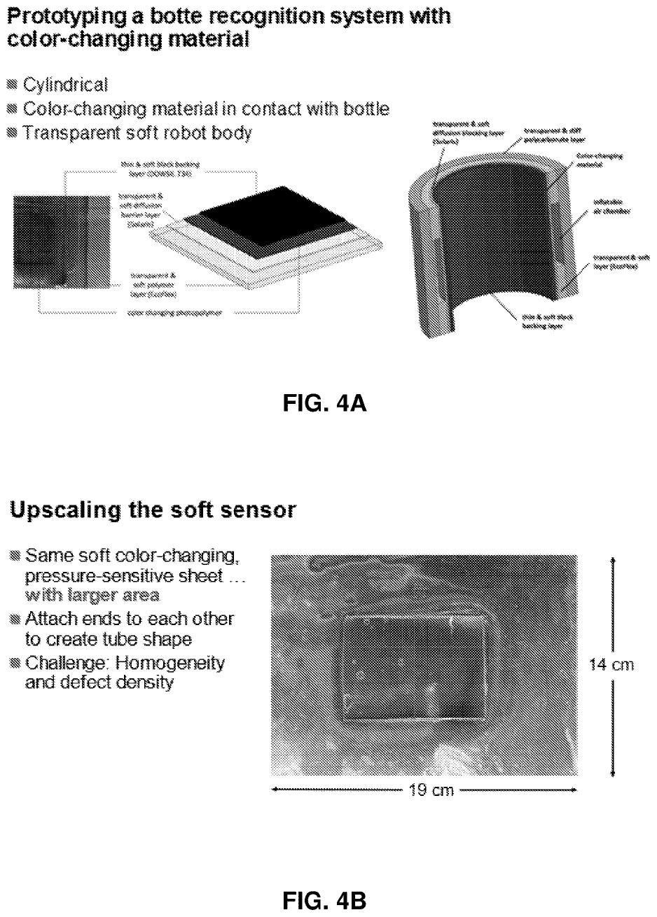

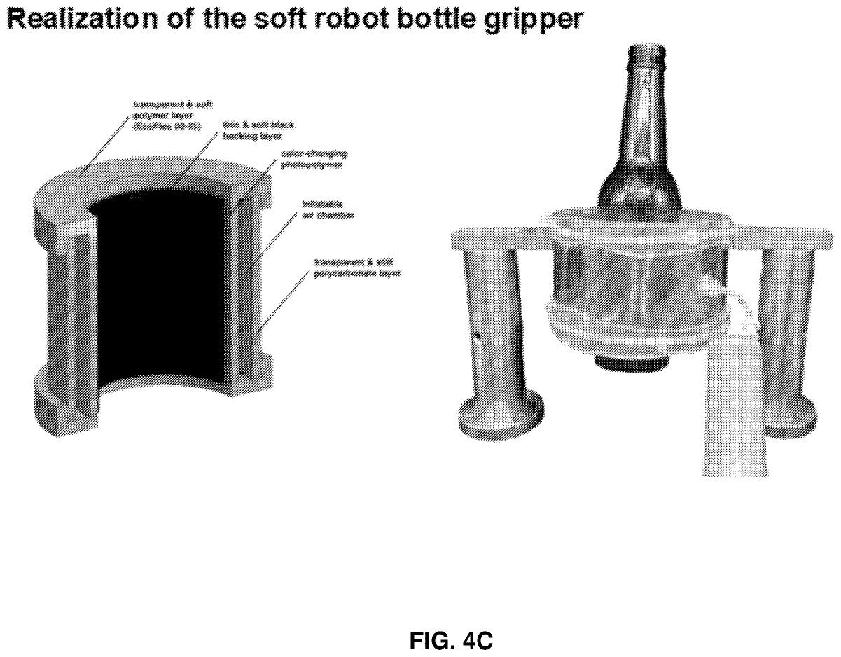

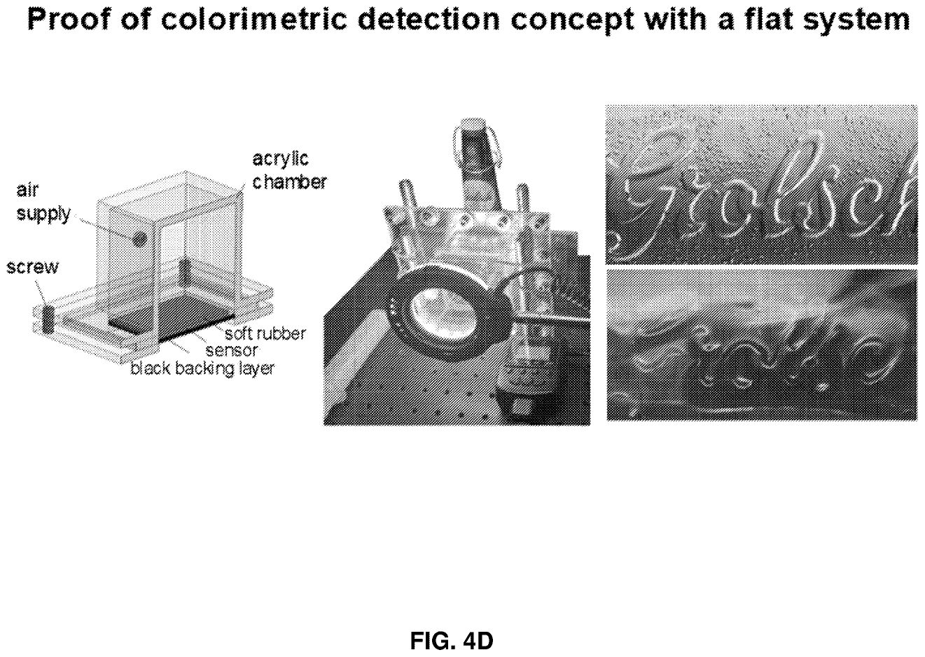

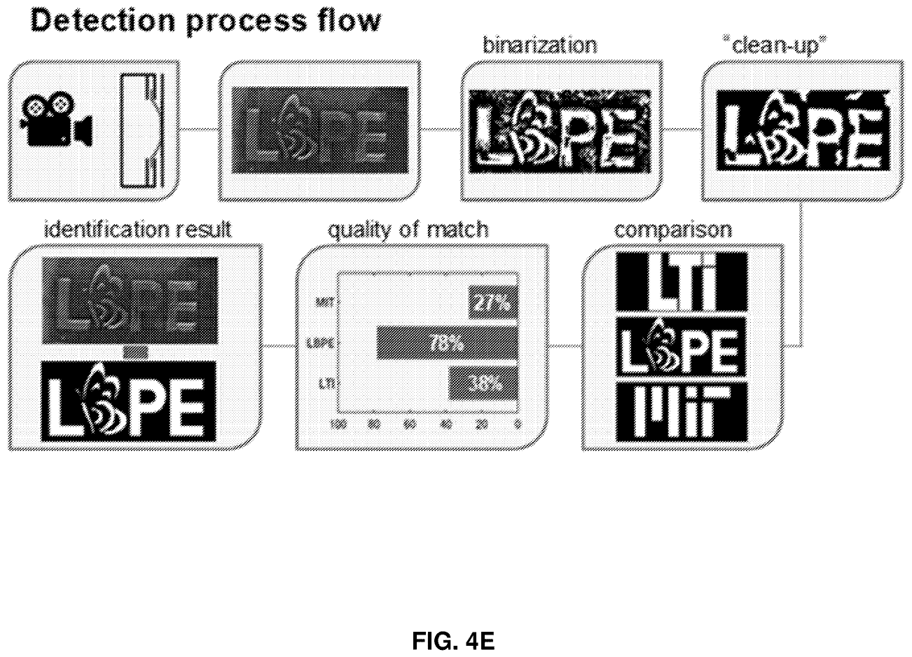

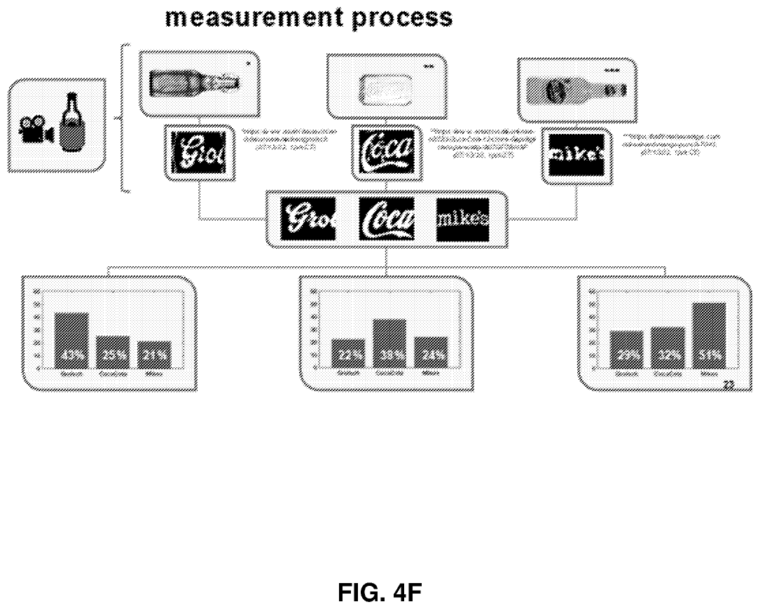

A bottle-sorting system was targeted as an example system, as many bottles include an elevated topography (such as an elevated label or logo) that can be readily imaged using the photonic materials described above. FIG. 4A and FIG. 4B illustrate several parameters considering for this example, including the shape of the apparatus, and considerations of the dimensions and sizing of the sensor.

The overall system for bottle identification is shown in FIG. 4C. The system was such that a cylindrical grip surrounds the bottle, and a chamber is filled with air to provide pressure to the photonic material within the grip. FIG. 4D illustrates how the surface topography of the bottle (e.g., the raised label of the bottle) could be used to image the bottle.

FIG. 4E illustrates how an identified topography of the bottle can be used to identify the bottle as whole. The image from the sensor can be further digitized and then compared (for example, comparing images in a stored database of a controller or cloud system). FIG. 4F illustrates this process using several bottles to compare.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A sensor, comprising:
a photonic material comprising a plurality of refractive index variations;
a backing layer adjacent to the photonic material, wherein the backing layer absorbs visible light; and
an optical input directed towards the photonic material.

2. The sensor of claim 1, wherein the photonic material comprises a plurality of voxels, wherein each voxel comprises a set of refractive index variations.

3. The sensor of claim 1, wherein the photonic material has a Young's modulus of less than or equal to 10,000 kPa and greater than or equal to 1 kPa.

4. The sensor of claim 1, wherein the photonic material comprises microscale refractive index variations.

5. The sensor of claim 1, wherein the photonic material comprises nanoscale refractive index variations.

6. The sensor of claim 1, wherein the photonic material comprises a first set of refractive index variations and a second set of refractive index variations distinct from the first set of refractive index variations.

7. The sensor of claim 1, wherein the photonic material comprises a photopolymer.

8. (canceled)

9. The sensor of claim 1, wherein the photonic material exhibits reversible color variation under applied mechanical force.

10-12. (canceled)

13. The sensor of claim 1, further comprising a blocking layer adjacent to the photonic material, wherein the blocking layer is capable of reducing diffusion between the photonic material and the backing layer.

14-16. (canceled)

17. An apparatus, comprising:
a photonic material comprising a plurality of refractive index variations;
a backing layer adjacent to the photonic material;
a blocking layer adjacent to the photonic material; and
a chamber adjacent to the blocking layer, wherein the chamber is configured to apply pressure to the blocking layer, the photonic material, and/or the backing layer.

18. The apparatus of claim 17, further comprising a grip, wherein the backing layer is disposed on the grip.

19. (canceled)

20. The apparatus of claim 17, wherein the chamber is an air chamber configured to receive compressed air.

21. The apparatus of claim 17, further comprising a gas cylinder operatively associated with the chamber.

22. (canceled)

23. The apparatus of claim 17, wherein the photonic material comprises microscale refractive index variations.

24. The apparatus of claim 17, wherein the photonic material comprises nanoscale refractive index variations.

25. The apparatus of claim 17, wherein the photonic material comprises a first set of refractive index variations and a second set of refractive index variations distinct from the first set of refractive index variations.

26-36. (canceled)

37. An object recognition system, the system comprising:
a photonic material comprising a plurality of refractive index variations;
a backing layer adjacent to the photonic material;
a blocking layer adjacent to the photonic material; and
an optical input directed towards the photonic material.

38. The system of claim 37, further comprising an object, wherein the object comprises an identifiable topography.

39. (canceled)

40. The system of claim 38, wherein an object is selected from a recyclable object, a manufactured object, a consumer good, a food object, and/or clothing.

41. The system of claim 37, further comprising a grip, wherein the backing layer is disposed on the grip.

42-81. (canceled)
